(19) United States
(12) Patent Application Publication
(10) Pub. No.: US 2026/0036760 A1
(43) Pub. Date: Feb. 5, 2026

(54) CO-PACKAGED PHOTONICS FIBER CONNECTOR

(71) Applicant: ACON OPTICS COMMUNICATIONS INC., New Taipei City (TW)

(72) Inventors: Jia Rong Wu, New Taipei City (TW); Tsung Yao Hsu, New Taipei City (TW)

(73) Assignee: ACON OPTICS COMMUNICATIONS INC., New Taipei City (TW)

(21) Appl. No.: 19/287,740

(22) Filed: Jul. 31, 2025

Related U.S. Application Data
(60) Provisional application No. 63/678,558, filed on Aug. 2, 2024.

(51) Int. Cl. G02B 6/38

(52) U.S. Cl. CPC G02B 6/3831; G02B 6/3897

(57) ABSTRACT

A co-packaged photonics fiber connector is configured on a photonic integrated circuit (PIC) to receive an optical fiber assembly and optically couple the optical fiber assembly to the PIC. The co-packaged photonics fiber connector includes a housing mounted on the PIC, an intermediate member, and a spring sheet. The housing includes a shaft portion and a slot, in which the optical fiber assembly is configured to be inserted into the slot or removed from the slot. A portion of the spring sheet is pivotally hooked onto the shaft portion such that the spring sheet pivots relative to the housing about the shaft portion. In a fixed state, the optical fiber assembly and the intermediate member are inserted into the slot, and at least another portion of the spring sheet abuts the intermediate member to fix the optical fiber assembly in the slot through the intermediate member.

### CROSS-REFERENCE TO RELATED APPLICATION

This application claims the priority benefit of U.S. provisional application Ser. No. 63/678,558, filed on Aug. 2, 2024. The entirety of the above-mentioned patent application is hereby incorporated by reference herein and made a part of this specification.

### BACKGROUND

### Technical Field

The disclosure relates to a photonics connector, and particularly relates to a co-packaged photonics fiber connector.

### Description of Related Art

Co-packaged optics (CPO) refer to a technology in which optical elements and electronic components are co-packaged on the same substrate, intended to improve data transmission efficiency, minimize power consumption and cost, and shrink system size. The CPO reduces losses caused by optical signals in traditional packaging by more closely integrating optical elements into electronic chips and enhances both signal transmission speed and bandwidth. Additionally, by shortening optical signal transmission paths, the CPO can further reduce the energy required for signal transmission, thereby decreasing overall power consumption.

### SUMMARY

The disclosure provides a co-packaged photonics fiber connector that enables an optical fiber assembly and a photonic integrated circuit (PIC) to be rapidly combined with or separated from each other through the assembly and disassembly of a fixing mechanism, without damage to the optical fiber assembly.

A co-packaged photonics fiber connector of the disclosure is configured on a PIC to receive an optical fiber assembly and optically couple the optical fiber assembly to the PIC. The co-packaged photonics fiber connector includes a housing, an intermediate member, and a spring sheet. The housing is mounted on the PIC. The housing includes a shaft portion and a slot, in which the optical fiber assembly is configured to be inserted into the slot or removed from the slot. The intermediate member is inserted into the slot to cover the optical fiber assembly or removed away from the slot. A portion of the spring sheet is pivotally hooked onto the shaft portion such that the spring sheet pivots relative to the housing about the shaft portion. In a fixed state, the optical fiber assembly and the intermediate member are inserted into the slot, and at least another portion of the spring sheet abuts the intermediate member to fix the optical fiber assembly in the slot through the intermediate member.

Based on the above, in the co-packaged photonics fiber connector, the spring sheet is assembled to the housing and is able to pivot relative to the housing. After the optical fiber assembly is inserted into the slot together with the intermediate member to cover the optical fiber assembly, the spring sheet is pivoted and locked with at least one of the housing and the intermediate member, so that the elastic force of the spring sheet may press the optical fiber assembly through the intermediate member to fix the optical fiber assembly in the slot of the housing. Such an arrangement not only allows the optical fiber assembly and the PIC to achieve rapid assembly and disassembly through the cooperation between the spring sheet, housing, and intermediate member, but also ensures that the spring sheet pivotally disposed on the housing abuts the intermediate member. Therefore, it may effectively achieve the purpose of protecting the optical fiber assembly through the intermediate member, thereby further providing a stable assembly mechanism for the optical fiber assembly and the PIC and improving the lifetime of the optical fiber assembly.

### BRIEF DESCRIPTION OF THE DRAWINGS

FIG. 1A is a schematic view of a co-packaged photonics fiber connector according to an embodiment of the disclosure.

FIG. 1B illustrates the co-packaged photonics fiber connector of FIG. 1A from another viewing angle.

FIG. 1C illustrates another state of the co-packaged photonics fiber connector of FIG. 1A.

FIG. 2A is an exploded view of a co-packaged photonics fiber connector.

FIG. 2B illustrates an intermediate member from another viewing angle.

FIG. 2C illustrates a combined state of an intermediate member and an optical fiber assembly.

FIG. 3A is a side view of a co-packaged photonics fiber connector.

FIG. 3B is a cross-sectional view of a co-packaged photonics fiber connector.

FIG. 4A is an exploded view of a co-packaged photonics fiber connector according to another embodiment of the disclosure.

FIG. 4B illustrates the exploded view of FIG. 4A from another viewing angle.

FIG. 5A is a schematic view of assembling the co-packaged photonics fiber connector of FIG. 4A.

FIG. 5B is a partial schematic view of FIG. 5A.

FIG. 6A is a schematic view of an optical fiber assembly according to another embodiment of the disclosure.

FIG. 6B is a schematic view of assembling the optical fiber assembly of FIG. 6A with an intermediate member and a spacer.

### DESCRIPTION OF THE EMBODIMENTS

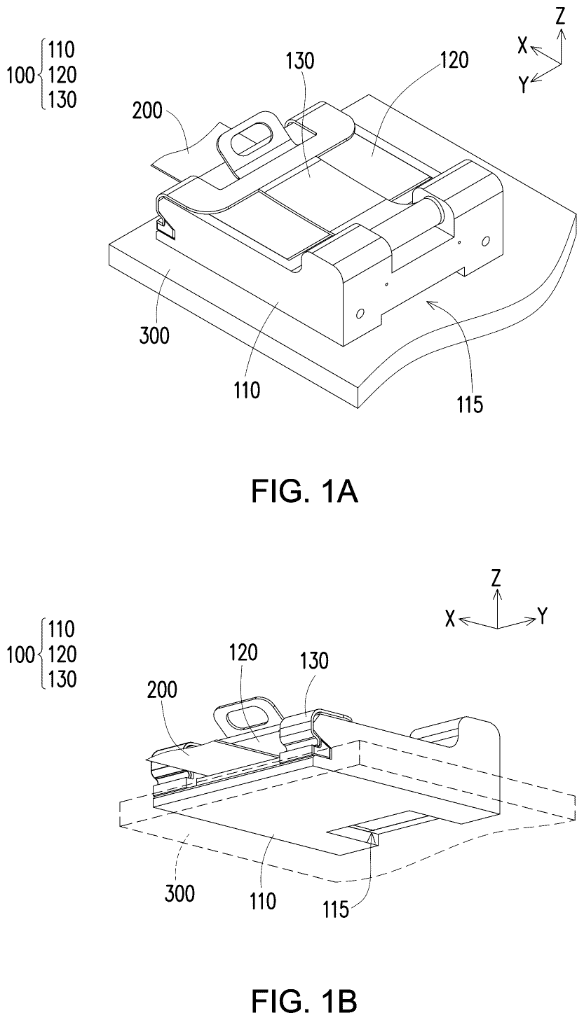

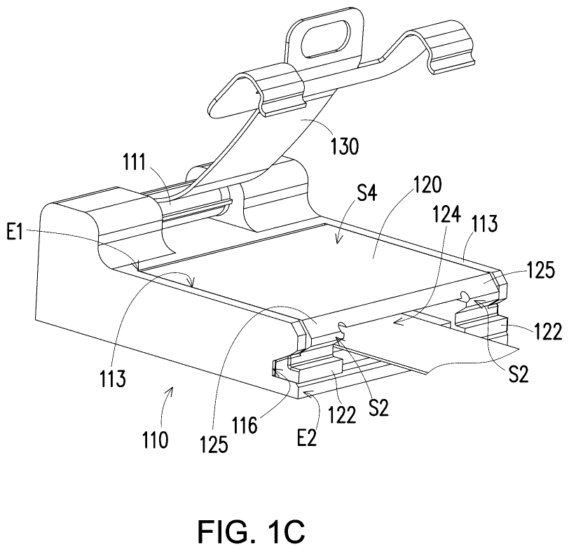

FIG. 1A is a schematic view of a co-packaged photonics fiber connector according to an embodiment of the disclosure. FIG. 1B illustrates the co-packaged photonics fiber connector of FIG. 1A from another viewing angle. FIG. 1C illustrates another state of the co-packaged photonics fiber connector of FIG. 1A. Referring to FIG. 1A to FIG. 1C at the same time, the embodiment also provides rectangular coordinates X-Y-Z to facilitate component description. A co-packaged photonics fiber connector 100 is disposed on a photonic integrated circuit (PIC) 300 to receive an optical fiber assembly 200 and optically couple the optical fiber assembly 200 to the PIC 300. Here, the PIC 300 utilizes semiconductor processes to directly fabricate optical elements such as modulators, switches, splitters, etc., in an integrated circuit, forming a compact optoelectronic integrated circuit element. In contrast to electronic integrated circuits, which transmit electrons, integrated optical elements mainly transmit optical signals in visible light or infrared wavelengths, and the connection of various elements in the circuit is completed by optical waveguides. Through such miniaturized, highly stable integrated optical elements, optoelectronic communication systems are able to demonstrate increasingly greater functionality and efficacy.

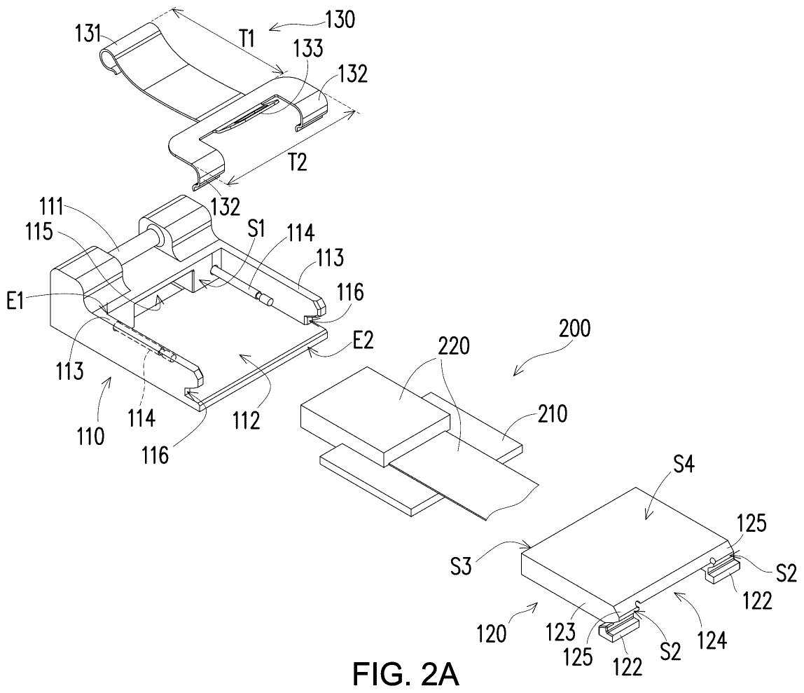

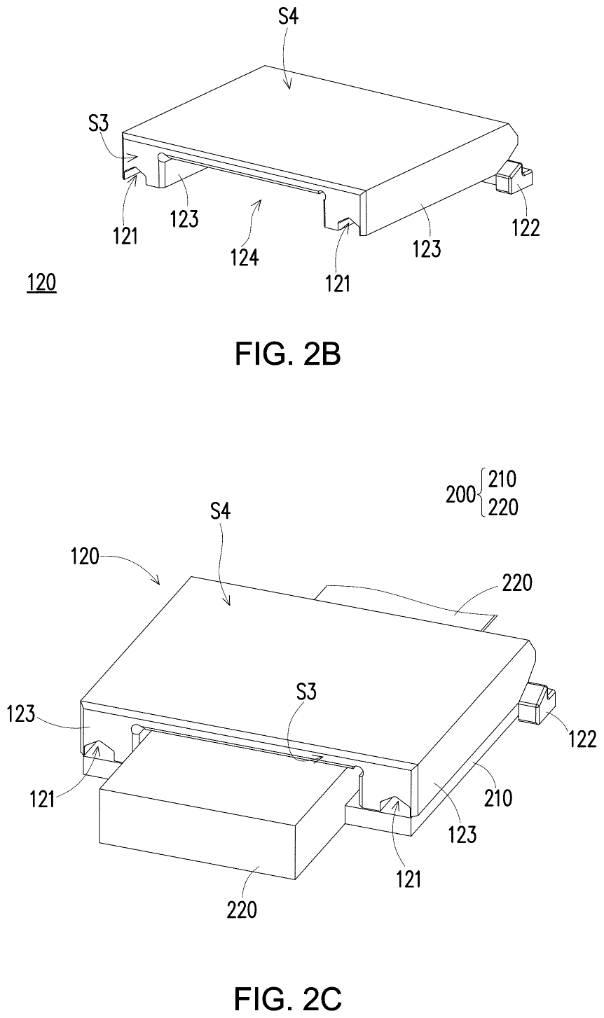

FIG. 2A is an exploded view of a co-packaged photonics fiber connector. Referring to FIG. 1A, FIG. 1C, and FIG. 2A at the same time, in the embodiment, the co-packaged photonics fiber connector 100 includes a housing 110, an intermediate member 120, and a spring sheet 130. The housing 110 is mounted on the PIC 300. The housing 110 includes a shaft portion 111 and a slot 112. The optical fiber assembly 200 is configured to be inserted into the slot 112 or removed from the slot 112. The intermediate member 120 is inserted into the slot 112 to cover the optical fiber assembly 200 or removed away from the slot 112. A portion of the spring sheet 130 may be pivotally hooked onto the shaft portion 111 such that the spring sheet 130 pivots relative to the housing 110 about the shaft portion 111. In the embodiment, the housing 110 is located on the X-Y plane, and the shaft portion 111 is parallel to the X-axis or coincides with the X-axis. In a fixed state (as shown in FIG. 1A or FIG. 1B), the optical fiber assembly 200 and the intermediate member 120 move in the negative Y-axis direction and are inserted into the slot 112, the spring sheet 130 pivots relative to the X-axis such that at least another portion thereof abuts the intermediate member 120 to fix the optical fiber assembly 200 in the slot 112 through the intermediate member 120. Conversely, when the spring sheet 130 pivots relative to the housing 110 and moves away from the intermediate member 120, as shown in FIG. 1C, the intermediate member 120 and the optical fiber assembly 200 may be removed from the slot 112 in the positive Y-axis direction.

Furthermore, as shown in FIG. 2A, the housing 110 includes two side walls 113 and an inner stop surface S1 that form the slot 112, in which the two side walls 113 are opposite to each other, and the inner stop surface S1 is adjacent between the two side walls 113. In the fixed state (as shown in the aforementioned FIG. 1A or FIG. 1B), an outer side surface S2 of the intermediate member 120 is abutted by the spring sheet 130 such that an inner side surface S3 of the intermediate member 120 abuts the inner stop surface S1. The outer side surface S2 and the inner side surface S3 are two opposite surfaces of the intermediate member 120. Furthermore, FIG. 2B illustrates an intermediate member from another viewing angle, and FIG. 2C illustrates a combined state of an intermediate member and an optical fiber assembly. Referring to FIG. 2A to FIG. 2C at the same time, the housing 110 further includes a first guide post 114, extending from the inner stop surface S1 along the side wall 113 in the slot 112, and at least one of the intermediate member 120 and the optical fiber assembly 200 includes a first guide slot (the embodiment takes the intermediate member 120 having a first guide slot 121 as an example). The first guide post 114 is configured to the first guide slot 121, and during the process of inserting the optical fiber assembly 200 and the intermediate member 120 into the slot 112, the intermediate member 120 and the optical fiber assembly 200 are guided and positioned in the slot 112. Here, the housing 110 further includes a block 118 and a base plate 117. The block 118 includes the aforementioned inner stop surface S1. The base plate 117 and the two side walls 113 extend from the block 118 in the same direction and form the slot 112 with the inner stop surface S1, in which the shaft portion 111 to which the spring sheet 130 is pivotally connected is located on the block 118.

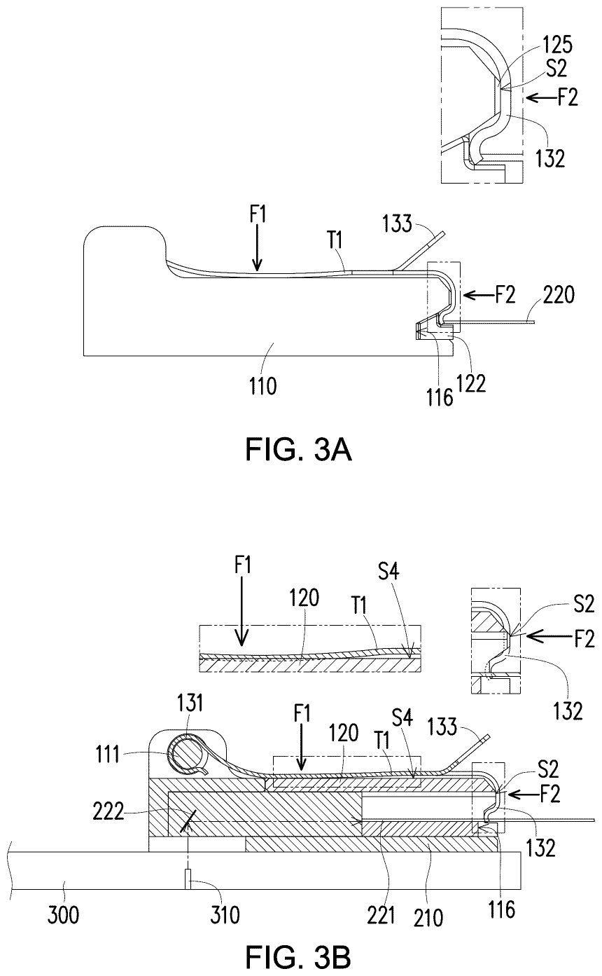

Referring to FIG. 1A, FIG. 1B, and FIG. 2A again, in the embodiment, the optical fiber assembly 200 includes an optical module 220 and a base 210. The optical module 220 is disposed on the base 210. The housing 110 includes a hollow portion 115, facing toward the PIC 300 and communicating with the slot 112. FIG. 3A is a side view of a co-packaged photonics fiber connector. FIG. 3B is a cross-sectional view of a co-packaged photonics fiber connector. Referring to FIG. 2A, FIG. 3A, and FIG. 3B at the same time, the optical module 220 of the embodiment includes a fiber (array) 221 and an optical element (array) 222, and the PIC 300 includes an optical waveguide 310. In the fixed state, the base 210 is located in the slot 112 and abuts the inner stop surface S1, the optical module 220 extends from the slot 112 to the hollow portion 115 to correspond to the PIC 300, and as shown in FIG. 3B, the optical fiber assembly 200 and the PIC 300 that complete optical coupling may transmit optical signals represented by dashed arrows from the optical waveguide 310 and optical element 222 to the fiber 221. In other words, through the co-packaged photonics fiber connector 100 of the disclosure, the optical coupling operation of the optical fiber assembly 200 and the PIC 300 may be completed efficiently and rapidly.

Referring to FIG. 1C, FIG. 2A, and FIG. 3A again, in the embodiment, the intermediate member 120 further includes a protruding stepped portion 122, located below the outer side surface S2. In the fixed state, the base 210 of the optical fiber assembly 200 may abut between the inner stop surface S1 and the protruding stepped portion 122. Here, the intermediate member 120 has an inverted U-shaped structure and includes two abutting ribs 123 opposite to each other and a groove 124 located between the two abutting ribs 123. The protruding stepped portion 122 extends from an end of the abutting rib 123. Therefore, in the fixed state, the groove 124 accommodates the optical module 220. The abutting rib 123 contacts the side wall 113 of the housing 110, abuts the inner stop surface S1, and is stacked on the base 210 of the optical fiber assembly 200. A portion of the protruding stepped portion 122 extends away from the groove 124 and fills in an end notch 116 of the side wall 113, and another portion of the protruding stepped portion 122 abuts the base 210. Also as shown in FIG. 1B and FIG. 1C, the intermediate member 120 includes a protruding portion 125. The protruding portion 125 includes the aforementioned outer side surface S2 and forms a notch structure with the protruding stepped portion 122 so that the spring sheet 130 may be locked with it.

In this way, referring to FIG. 2A, FIG. 3A, and FIG. 3B at the same time, the structural features of the spring sheet 130 shown in FIG. 2A facilitate understanding of the force applied by the spring sheet 130 to the intermediate member 120 in FIG. 3A and FIG. 3B and its further effect on the optical fiber assembly 200. In the embodiment, the spring sheet 130 has a T-shape and includes a transverse section T2 and a straight section T. The straight section T1 intersects at a center of the transverse section T2. One end of the straight section T1 away from the transverse section T2 includes a pivot portion 131. The pivot portion 131 may pivotally wrap around the shaft portion 111. The straight section T1 has a bent shape. In the fixed state, the straight section T1 deforms to accumulate the elastic force due to an interference with a top surface S4 of the intermediate member 120 such that a first force F1 is applied to the top surface S4 to press the intermediate member 120 in the slot 112, and press the optical fiber assembly 200 between the intermediate member 120 and the slot bottom of the slot 112 (i.e., the base plate 117 of the housing 110).

Furthermore, each of the two opposite ends of the transverse section T2 includes a first hook 132. In the fixed state, the first hook 132 is locked with the intermediate member 120 and the housing 110. The slot 112 includes a first end E1 and a second end E2 opposite to each other. The shaft portion 111 is located at the first end E1. The optical fiber assembly 200 and the intermediate member 120 are configured to move from the second end E2 toward the first end E1 to be inserted into the slot 112, or move from the first end E1 toward the second end E2 to be removed from the slot 112. In the fixed state, an inner side of the notch of the first hook 132 abuts the outer side surface S2 of the intermediate member 120, while an end of the first hook 132 is locked with the intermediate member 120 and the end notch 116 of the housing 110 at its side wall 113 at the same time. The first hook 132 deforms to accumulate the elastic force due to an interference between the inner side of the notch and the outer side surface S2 of the intermediate member 120 such that a second force F2 is applied to the outer side surface S2 from the second end E2 toward the first end E1 to press the optical fiber assembly 200 between the intermediate member 120 and the housing 110. Through the aforementioned first force F1 and second force F2 of the spring sheet 130, the optical fiber assembly 200, while being locked with the intermediate member 120, may also be clamped and pressed between the intermediate member 120 and the housing 110, thereby completing the purpose of being fixed on the PIC 300. The embodiment improves the assembly precision of the mechanism and effectively simplifies the number of components through the integral structure housing 110 and the spring sheet 130 having a single hook (first hook 132).

In the embodiment, FIG. 3B additionally provides a schematic view of the partial interference of the spring sheet 130 and the intermediate member 120 for reference, in which the portion where the spring sheet 130 interferes with the intermediate member 120 is illustrated with dashed lines to represent its interference amount, which also corresponds to the deformation amount of the spring sheet 130 at that location, thereby enabling smooth provision of the first force F1 and the second force F2.

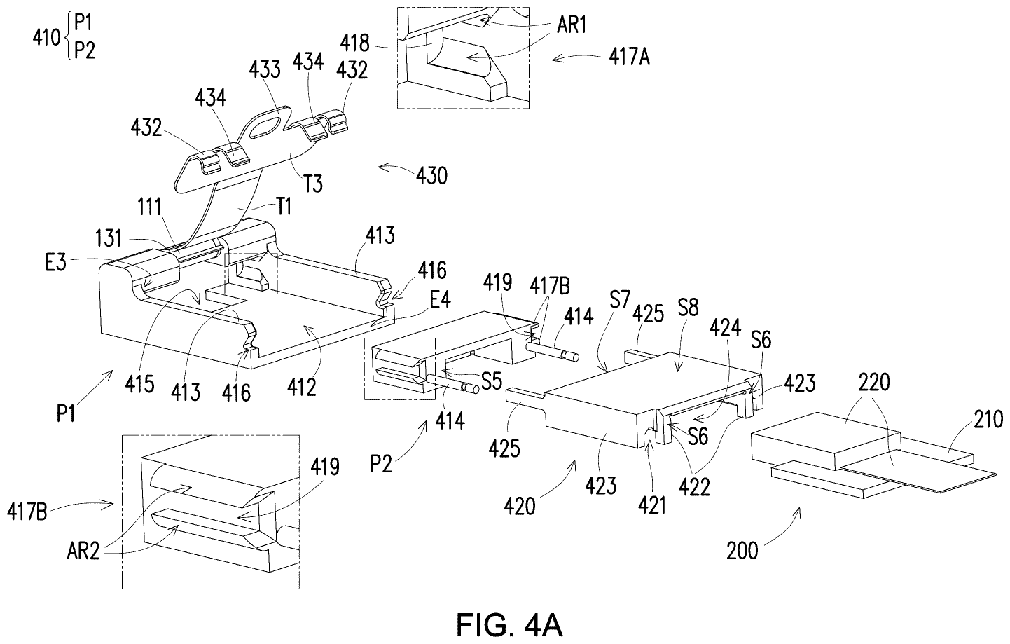

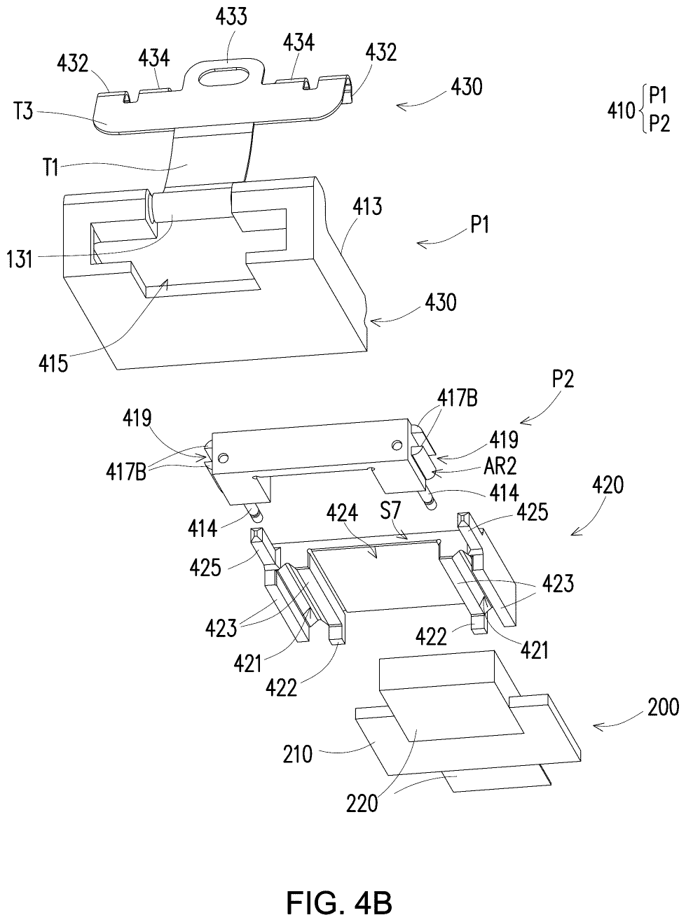

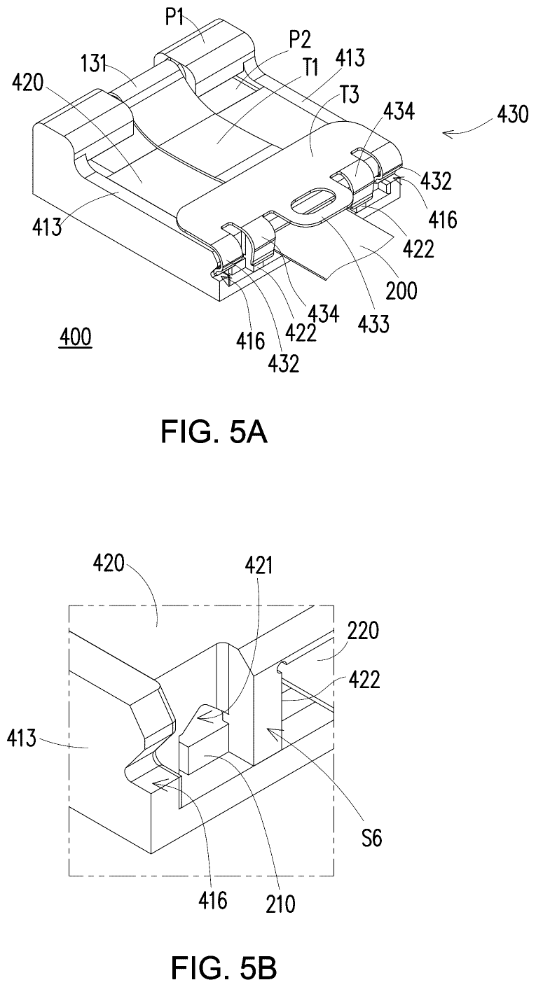

As also shown in FIG. 1C and FIG. 2A, the spring sheet 130 of the embodiment further includes a pull handle 133, extending from the center of the transverse section T2 and opposite to the straight section T1, to enable the user to pivot the spring sheet 130 relative to the housing 110. FIG. 4A is an exploded view of a co-packaged photonics fiber connector according to another embodiment of the disclosure. FIG. 4B illustrates the exploded view of FIG. 4A from another viewing angle. FIG. 5A is a schematic view of assembling the co-packaged photonics fiber connector of FIG. 4A. Referring to FIG. 4A, FIG. 4B, and FIG. 5A at the same time, different from the aforementioned embodiment, a co-packaged photonics fiber connector 400 of the embodiment includes a housing 410, an intermediate member 420, and a spring sheet 430. The housing 410 includes a carrier P1 and a spacer P2. The spacer P2 is assembled to the carrier P1, and the spacer P2 includes a first guide post 414 and an inner stop surface S5. The carrier P1 includes a shaft portion 111 and two side walls 413. The carrier P1 of the embodiment further includes a first arc-shaped track 417A, located on the side wall 413, and the spacer P2 includes a second arc-shaped track 417B. The spacer P2 is assembled into the carrier P1 by adapting to the first arc-shaped track 417A through the second arc-shaped track 417B, and is stopped by an end stop portion 418 of the first arc-shaped track 417A. When the spring sheet 430 is locked with and abuts the housing 410 and the intermediate member 420 to reach a fixed state, the spacer P2 abuts the interior of the slot 412, and then an inner side surface S7 of the intermediate member 420 abuts the inner stop surface S5 of the spacer P2, with the spring sheet 430 providing the clamping force required by the above components.

Further, in the embodiment, the first arc-shaped track 417A includes a pair of arc-shaped inner walls AR1 extending from the end stop portion 418, and the second arc-shaped track 417B includes a pair of arc-shaped outer walls AR2 configured to the arc-shaped inner walls AR1. Therefore, the spacer P2 may be inserted into the first arc-shaped track 417A through the second arc-shaped track 417B, until abutting and stopping at the end stop portion 418. Furthermore, a second guide slot 419 is provided between the arc-shaped outer walls AR2, and the intermediate member 420 further includes a second guide post 425, protruding from the inner side surface S7 and configured to the second guide slot 419. Therefore, as shown in FIG. 4A and FIG. 4B, the spacer P2 and the intermediate member 420 mutually have the first guide post 414, the first guide slot 421, and the second guide post 425, the second guide slot 419 that are configured to each other, enabling the spacer P2 and the intermediate member 420 to be smoothly assembled and positioned together, in which the intermediate member 420 also has an inverted U-shaped structure and includes an abutting rib 423, and the abutting rib 423 includes the aforementioned first guide slot 421.

Referring again to FIG. 4A and FIG. 4B, compared with the aforementioned embodiment, the carrier P1 of the embodiment is substantially the structure of the housing 110 of the aforementioned embodiment after removing the partial block 118. The carrier P1 of the embodiment similarly includes side walls 413 and a base plate (such as the base plate 117 of the aforementioned embodiment), according to which the required slot 412 is formed. The carrier P1 also includes a hollow portion 415, so that after the spacer P2 is moved into the slot 412, it substantially conforms to the housing 110 of the aforementioned embodiment, in which both have an inner stop surface S5 (the inner stop surface S1 of the aforementioned embodiment) for the intermediate member 420 to serve as abutment when being pressed by the elastic force of the spring sheet 430.

FIG. 5A is a schematic view of assembling the co-packaged photonics fiber connector of FIG. 4A. FIG. 5B is a partial schematic view of FIG. 5A, which omits the spring sheet 430 to facilitate identification of the corresponding relationship between the intermediate member 420 and the housing 410 at a second end E4 of the slot 412. Referring to FIG. 5A and FIG. 5B at the same time, the spring sheet 430 of the embodiment similarly has a T-shape and includes a transverse section T3 and a straight section T1. The straight section T1 intersects at the center of the transverse section T3. One end of the straight section T1 away from the transverse section T3 includes a pivot portion 131. The pivot portion 131 may pivotally wrap around the shaft portion 111. The straight section T1 has a bent shape. In the fixed state, the straight section T1 deforms to accumulate the elastic force due to an interference with a top surface S8 of the intermediate member 420 such that a first force (such as the first force F1 of the aforementioned embodiment) is applied to the top surface S8 to press the intermediate member 420 in the slot 412, and press the optical fiber assembly 200 between the intermediate member 420 and the slot bottom of the slot 412.

Furthermore, the two opposite ends of the transverse section T3 each have a first hook 432 and a second hook 434. In the fixed state, the first hook 432 is locked with an end notch 416 of the carrier P1 of the housing 410, and the second hook 434 abuts a post 422 of the intermediate member 420. The post 422 protrudes beyond the first guide slot 421 of the abutting rib 423. The slot 412 includes a first end E3 and a second end E4 that are opposite to each other. The shaft portion 111 is located at the first end E3. The optical fiber assembly 200 and the intermediate member 420 are configured to move from the second end E4 toward the first end E3 so as to be inserted into the slot 412, or move from the first end E3 toward the second end E4 to be removed from the slot 412. In the fixed state, the second hook 434 abuts an outer side surface S6 of the intermediate member 420, and the second hook 434 deforms to accumulate the elastic force due to an interference with the outer side surface S6 of the intermediate member 420 such that a second force (such as the aforementioned second force F2) is applied to the outer side surface S6 from the second end E4 toward the first end E3 to press the optical fiber assembly 200 between the intermediate member 420 and the housing 410. Additionally, similarly, the spring sheet 430 of the embodiment also includes a pull handle 433 located at the center of the transverse section T3, so as to facilitate user operation of the spring sheet 430 to pivot relative to the housing 410.

Compared with the embodiments shown in the aforementioned FIG. 1A to FIG. 3B, the embodiment is provided according to assembly requirements, in which the embodiment further divides the housing 410 into a carrier P1 and a spacer P2, thereby facilitating operators to first assemble the spacer P2, the intermediate member 420, and the optical fiber assembly 200, and then insert the combined three components together into the carrier P1 having the slot 412. It should be noted that the co-packaged photonics fiber connector 400 of the disclosure has external dimensions (length, width, height) of approximately 18 mm, 18 mm, 6.5 mm, which is not easy for operators to operate and results in reduced work efficiency. Therefore, through the structural reconfiguration of the housing 410 in the embodiment, the assembly efficiency may be significantly improved.

Additionally, in the embodiment, the first hook 432 and second hook 434 are respectively locked with and abut the corresponding housing 410 and intermediate member 420. Compared to the single hook (first hook 132) shown in the aforementioned FIG. 1A to FIG. 3B, the embodiment focuses on the dimensional correspondence relationship between the intermediate member 420 and the housing 410 (particularly its structure at the side wall 413). That is, considering that the spring sheet 430 needs to satisfy its engagement and pressing force for both the housing 410 and intermediate member 420 at the same time, the adoption of the bifurcated hooks (first hook 432, second hook 434) enables the elastic force to be adjusted in a timely manner through changes in the bending degree of the hooks in order to satisfy the requirements.

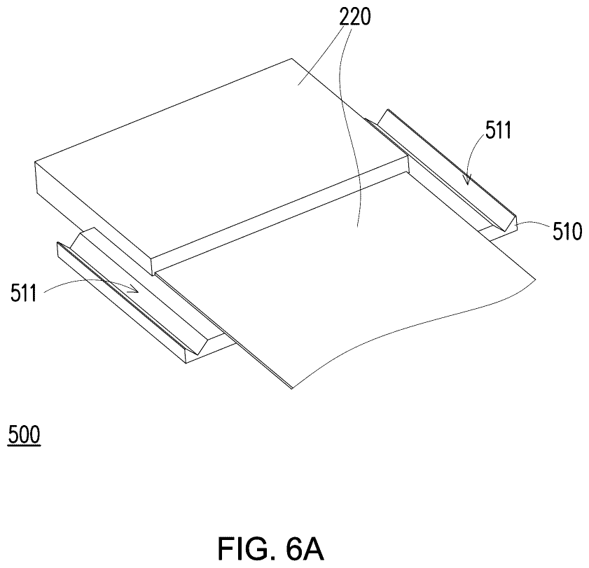

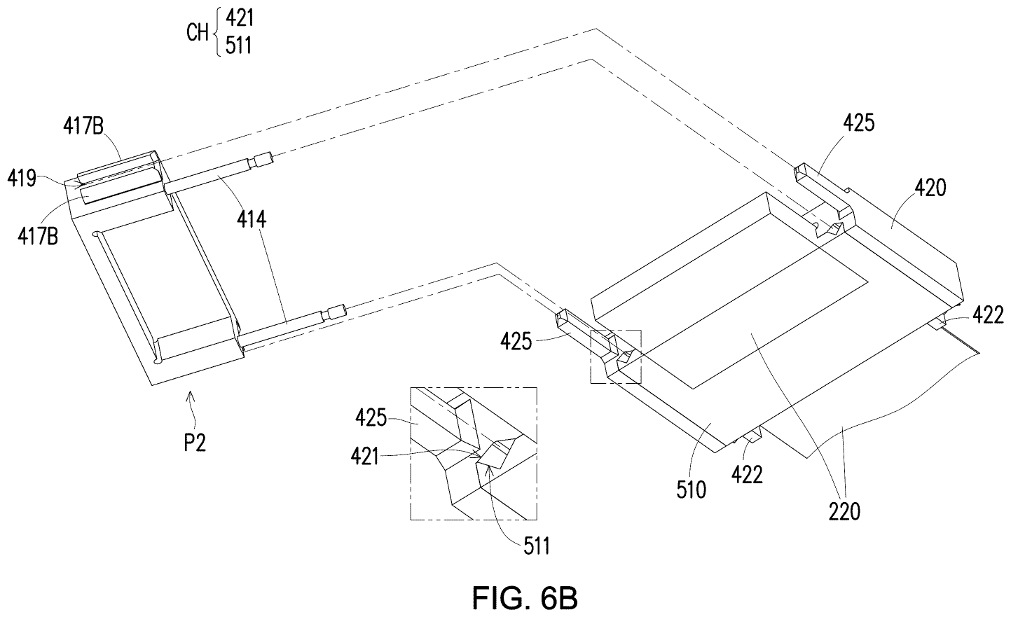

FIG. 6A is a schematic view of an optical fiber assembly according to another embodiment of the disclosure. FIG. 6B is a schematic view of assembling the optical fiber assembly of FIG. 6A with an intermediate member and a spacer. Referring to FIG. 6A and FIG. 6B at the same time, different from the aforementioned embodiments, in an optical fiber assembly 500 of the embodiment, an optical module 220 is disposed on a base 510, and the base 510 includes wing portions protruding from two opposite sides of the optical module 220, in which slots 511 are provided on the wing portions. Therefore, as shown in FIG. 6B, when the optical fiber assembly 500 is covered by the intermediate member 420 and is about to be assembled together with the spacer P2, the slots 511 will combine with the first guide slot 421 of the intermediate member 420 to form a new guide slot CH so as to adapt to the first guide post 414 of the spacer P2.

In summary, in the co-packaged photonics fiber connector of the above embodiments of the disclosure, the spring sheet is assembled to the housing and is able to pivot relative to the housing. After the optical fiber assembly is inserted into the slot together with the intermediate member to cover the optical fiber assembly, the spring sheet is pivoted and locked with at least one of the housing and the intermediate member, so that the elastic force of the spring sheet may press the optical fiber assembly through the intermediate member to secure the optical fiber assembly in the slot of the housing.

In one embodiment, the housing has an integral structure, that is, the housing may be manufactured through a single process to have better mechanical precision which is favorable for carrying and fixing the optical fiber assembly. In one embodiment, the housing is composed of a carrier and a spacer, in which the spacer includes an inner stop surface for the intermediate member to abut. This allows the optical fiber assembly to be first assembled with the intermediate member and the spacer, and then inserted into the slot of the housing, which is favorable for improving the convenience of the assembly process.

In one embodiment, one end of the spring sheet away from its pivot connection with the housing includes a single hook to be locked with the intermediate member and the side wall of the housing at the same time, and the intermediate member may also first abut the end notch of the side wall through the portion of its protruding stepped portion, so that the aforementioned single hook may also apply pressure on the side wall of the housing while being locked with the protruding stepped portion, so as to achieve a better and stable fixing effect. In one embodiment, one end of the spring sheet away from its pivot connection with the housing includes double hooks to respectively provide engagement and abutting effects to the intermediate member and the side wall of the housing. This may provide hooks with different elastic force properties according to the dimensions and fixing requirements of the intermediate member and housing to improve convenience during design.

Such an arrangement not only allows the optical fiber assembly and the PIC to achieve rapid assembly and disassembly through the cooperation between the spring sheet, housing, and intermediate member, but also ensures that the spring sheet pivotally disposed on the housing abuts the intermediate member. Therefore, it may effectively achieve the purpose of protecting the optical fiber assembly through the intermediate member, thereby further providing a stable assembly mechanism for the optical fiber assembly and the PIC and improving the lifetime of the optical fiber assembly.

What is claimed is:

1. A photonics fiber connector, disposed on a photonic integrated circuit (PIC) and configured to receive an optical fiber assembly and optically couple the optical fiber assembly to the PIC, the photonics fiber connector comprising:
a housing, mounted on the PIC, wherein the housing comprises a shaft portion and a slot, and the optical fiber assembly is configured to be inserted into the slot or removed from the slot;
an intermediate member, configured to be inserted into the slot to cover the optical fiber assembly or removed away from the slot; and
a spring sheet, wherein a portion of the spring sheet is pivotally hooked onto the shaft portion such that the spring sheet pivots relative to the housing about the shaft portion,
wherein in a fixed state, the optical fiber assembly and the intermediate member are inserted into the slot, and at least another portion of the spring sheet abuts the intermediate member to secure the optical fiber assembly in the slot through the intermediate member.

2. The photonics fiber connector according to claim 1, wherein the housing comprises two side walls and an inner stop surface defining the slot, the two side walls are opposite to each other, the inner stop surface is adjacent between the two side walls, in the fixed state, an outer side surface of the intermediate member is abutted by the spring sheet such that an inner side surface of the intermediate member abuts the inner stop surface, and the outer side surface and the inner side surface are two opposite surfaces of the intermediate member.

3. The photonics fiber connector according to claim 2, wherein the housing further comprises a first guide post extending from the inner stop surface along the side wall within the slot, and at least one of the intermediate member and the optical fiber assembly comprises a first guide slot such that the first guide post is configured to the first guide slot to guide and position the intermediate member and the optical fiber assembly in the slot during an insertion of the optical fiber assembly and the intermediate member into the slot.

4. The photonics fiber connector according to claim 3, wherein the housing comprises a carrier and a spacer, the spacer is assembled to the carrier, the spacer comprises the first guide post and the inner stop surface, and the carrier comprises the shaft portion and the two side walls.

5. The photonics fiber connector according to claim 4, wherein the carrier further comprises a first arc-shaped track located at the side wall, the spacer comprises a second arc-shaped track, and the spacer is assembled into the carrier by the second arc-shaped track being configured to the first arc-shaped track, and is stopped by an end stop portion of the first arc-shaped track.

6. The photonics fiber connector according to claim 5, wherein the first arc-shaped track comprises a pair of arc-shaped inner walls extending from the end stop portion, and the second arc-shaped track comprises a pair of arc-shaped outer walls configured to the pair of arc-shaped inner walls.

7. The photonics fiber connector according to claim 6, wherein a second guide slot is provided between the pair of arc-shaped outer walls, and the intermediate member further comprises a second guide post protruding from the inner side surface and configured to the second guide slot.

8. The photonics fiber connector according to claim 3, wherein the optical fiber assembly comprises an optical module and a base, the optical module is disposed on the base, and a wing portion of the base protruding from the optical module comprises the first guide slot.

9. The photonics fiber connector according to claim 2, wherein the housing comprises a hollow portion facing the PIC and communicating with the slot, the optical fiber assembly comprises an optical module and a base, the optical module is disposed on the base, in the fixed state, the base is located in the slot and abuts the inner stop surface, and the optical module extends from the slot to the hollow portion to correspond to the PIC.

10. The photonics fiber connector according to claim 2, wherein the intermediate member further comprises a protruding stepped portion located below the outer side surface, the optical fiber assembly comprises an optical module and a base, the optical module is disposed on the base, and in the fixed state, the base is abutted between the inner stop surface and the protruding stepped portion.

11. The photonics fiber connector according to claim 10, wherein the intermediate member has an inverted U-shaped structure and comprises two abutting ribs opposite to each other and a groove located between the two abutting ribs, the protruding stepped portion extends from an end of the abutting rib, in the fixed state, the groove accommodates the optical module, the abutting rib contacts the side wall, abuts the inner stop surface, and is stacked on the base, a portion of the protruding stepped portion extends away from the groove and fills in an end notch of the side wall, and another portion of the protruding stepped portion abuts the base.

12. The photonics fiber connector according to claim 11, wherein the intermediate member comprises a protruding portion, the protruding portion comprises the outer side surface and forms a notch with the protruding stepped portion so that the spring sheet is locked with the notch.

13. The photonics fiber connector according to claim 2, wherein the housing further comprises a block and a base plate, the block comprises the inner stop surface, the base plate and the two side walls extend from the block in a same direction and form the slot with the inner stop surface, and the shaft portion is located on the block.

14. The photonics fiber connector according to claim 1, wherein the spring sheet has a T-shape and comprises a transverse section and a straight section, the straight section intersects at a center of the transverse section, an end of the straight section away from the transverse section comprises a pivot portion, the pivot portion pivotally wraps around the shaft portion, the straight section has a bent shape, and in the fixed state, the straight section deforms to accumulate an elastic force due to an interference with a top surface of the intermediate member such that a first force is applied to the top surface to press the intermediate member in the slot, and press the optical fiber assembly between the intermediate member and a slot bottom of the slot.

15. The photonics fiber connector according to claim 14, wherein two opposite ends of the transverse section each have a first hook, and in the fixed state, the first hook is locked with the intermediate member and the housing.

16. The photonics fiber connector according to claim 15, wherein the slot comprises a first end and a second end opposite to each other, the shaft portion is located at the first end, the optical fiber assembly and the intermediate member are configured to move from the second end toward the first end to be inserted into the slot, or move from the first end toward the second end to be removed from the slot, in the fixed state, an inner side of a notch of the first hook abuts an outer side surface of the intermediate member, and an end of the first hook is locked with the intermediate member and the housing at the same time.

17. The photonics fiber connector according to claim 16, wherein in the fixed state, the first hook deforms to accumulate an elastic force due to an interference between the inner side of the notch and the outer side surface of the intermediate member such that a second force is applied to the outer side surface from the second end toward the first end to press the optical fiber assembly between the intermediate member and the housing.

18. The photonics fiber connector according to claim 14, wherein two opposite ends of the transverse section each have a first hook and a second hook, in the fixed state, the first hook is locked with the housing, and the second hook abuts the intermediate member.

19. The photonics fiber connector according to claim 18, wherein the slot comprises a first end and a second end opposite to each other, the shaft portion is located at the first end, the optical fiber assembly and the intermediate member are configured to move from the second end toward the first end to be inserted into the slot, or move from the first end toward the second end to be removed from the slot, in the fixed state, the second hook abuts an outer side surface of the intermediate member, and the second hook deforms to accumulate an elastic force due to an interference with the outer side surface of the intermediate member such that a second force is applied to the outer side surface from the second end toward the first end to press the optical fiber assembly between the intermediate member and the housing.

20. The photonics fiber connector according to claim 14, wherein the spring sheet further comprises a pull handle extending from the center of the transverse section and opposite to the straight section.
